(19) United States
(12) Patent Application Publication
(10) Pub. No.: US 2026/0358171 A1
(43) Pub. Date: Nov. 12, 2026

(54) SOLAR IRRADIANCE SENSOR CALIBRATION

(71) Applicant: SOLARGIK LTD, JERUSALEM (IL)

(72) Inventors: Gil KROYZER, Jerusalem (IL); Israel KROIZER, Jerusalem (IL); Joseph Schwarzbach, Jerusalem (IL); Yuval SHIFRISS, Jerusalem (IL); Ben SHALOM, Rechovot (IL); Morag Am-Shallem, Jerusalem (IL)

(21) Appl. No.: 19/204,556

(22) Filed: May 11, 2025

(51) Int. Cl. G01J 1/42; G01J 1/02; H02S 50/00

(52) U.S. Cl. CPC G01J 1/42; G01J 1/0295; H02S 50/00; G01J 2001/4266

(57) ABSTRACT

A method of calibrating an irradiance sensor of a solar energy system comprises receiving a plurality of measured values of solar irradiance from the irradiance sensor for a period of time characterized by clear-sky conditions, accessing satellite irradiance data for the period of time, for a location including the irradiance sensor, and comparing the plurality of received measured values with the accessed satellite data to calculate a calibration function for the irradiance sensor. The receiving, accessing and comparing can all be carried out by a computing arrangement.

### FIELD OF THE INVENTION

The present invention relates to solar energy systems and in particular to calibrating irradiance sensors used in solar energy systems using data sourced from satellites.

### BACKGROUND

Achieving a diversified low-carbon emissions energy economy has been limited by economic and technological limitations. Solar energy systems comprising photovoltaic (PV) modules are commonly deployed to capture energy from both direct and diffuse (including reflected) solar irradiance. Tracking PV systems are deployed in which PV modules are pivoted to reduce optical losses from the direct irradiance component, including the so-called cosine loses wherein the energy absorbed is a function of the cosine of the angle between the incidence vector and a normal vector of the PV module.

PV modules serve to generate electricity when solar illumination is incident upon the panels. Generated electricity is typically fed into an electrical grid of the city/locality.

Irradiance sensors are deployed in solar energy systems to serve a number of purposes ranging from tracking electricity production as a function of available irradiance to setting cleaning schedules and determining how to operating a tracking system in the absence of direction radiation. Irradiance sensors can be affected by installation, maintenance and environmental issues that result in reduced and/or skewed data. It can be desirable to calibrate irradiance sensors by methods, including, for example remote calibration, to obviate the need for on-site inspection of the sensor.

### SUMMARY

According to embodiments, a weather station comprises: (a) an irradiance sensor; and (b) a computing arrangement comprising one or more processors and a non-transient computer-readable medium storing program instructions that, when executed by the one or more processors, cause the one or more processors to: (i) receive, from the irradiance sensor, a plurality of measured values of solar irradiance for a period of time characterized by clear-sky conditions, (ii) access satellite irradiance data for the period of time, for a location including the irradiance sensor, and (iii) compare the plurality of received measured values with the accessed satellite data to calculate a calibration function for the irradiance sensor.

In some embodiments, the period of time can be selected to improve a correlation between a spectral distribution of solar irradiance and a target spectral response of the PV modules.

In some embodiments, the plurality of received measured values of solar irradiance can be for a plurality of non-contiguous periods of time, and/or the accessed satellite irradiance data can be for the plurality of non-contiguous periods of time. In some embodiments, the plurality of non-contiguous periods of time can comprise first and second periods of time respectively characterized by different weighted averages of spectral wavelengths of visible light in the solar irradiance. In some embodiments, the plurality of non-contiguous periods of time can be selected to increase a difference in the respective weighted averages of spectral wavelengths of the first and second periods of time. In some embodiments, the plurality of non-contiguous periods of time can be selected to maximize a difference in the respective weighted averages of spectral wavelengths of the first and second periods of time. In some embodiments, the plurality of non-contiguous periods of time can be selected so that a difference in the respective weighted averages of spectral wavelengths between the first and second periods of time is greater than a threshold. In some embodiments, the plurality of non-contiguous periods of time are selected so that a difference in levels of solar irradiance between the first and second periods of time is greater than a threshold. In some embodiments, at least one of the plurality of periods of time can be selected to improve a correlation between a spectral distribution of solar irradiance and a target spectral response. In some embodiments, at least one of the plurality of periods of time can be selected to maximize a correlation between a spectral distribution of solar irradiance and a target spectral response.

In some embodiments, the calculating of the value of the parameter of the calibration function can be based in part on a weighted average of spectral wavelengths of visible light in the irradiance.

In some embodiments, the non-transient computer-readable medium can additionally store program instructions that, when executed by the one or more processors, cause the one or more processors to identify one or more periods of time as being characterized by clear-sky conditions.

In some embodiments, the non-transient computer-readable medium can additionally store program instructions that, when executed by the one or more processors, cause the one or more processors to report a fault in the irradiance sensor, responsively to the calculating of the value of the parameter of the calibration function. In some embodiments, calculating the value of the parameter of the calibration function can include using a multiplicative factor. In some embodiments, calculating the value of the parameter of the calibration can include using an arithmetic factor to correct for bias in the received measured values. In some embodiments, the calibration function can be time-of-day and/or time-of-year dependent. In some embodiments, the calibration function can compensate for an orientation of the irradiance sensor.

In some embodiments, calculating the value of the parameter of the calibration function can include estimating bias in the received measured values and compensating for said bias.

In some embodiments, a computing arrangement for the weather station can be provided with any or all of the abovementioned program instructions.

In some embodiments, a solar energy system can comprise the weather station according to any one of the foregoing embodiments, a plurality of photovoltaic (PV) modules and, optionally, one or more motor assemblies configured to pivot the PV modules through respective orientations.

According to embodiments, a solar energy system comprises: (a) a plurality of photovoltaic (PV) modules and, optionally, one or more motor assemblies configured to pivot the PV modules through respective orientations; (b) an irradiance sensor; and (c) a control system comprising one or more processors and a non-transient computer-readable medium storing program instructions that, when executed by the one or more processors, cause the one or more processors to: (i) receive, from the irradiance sensor, a plurality of measured values of solar irradiance for a period of time characterized by clear-sky conditions, (ii) access satellite irradiance data for the period of time, for a location including the irradiance sensor, and (iii) compare the plurality of received measured values with the accessed satellite data to calculate a calibration function for the irradiance sensor.

In some embodiments, the period of time can be selected to improve a correlation between a spectral distribution of solar irradiance and a spectral response of the PV modules.

In some embodiments, the plurality of received measured values of solar irradiance can be for a plurality of non-contiguous periods of time, and the accessed satellite irradiance data is for the plurality of non-contiguous periods of time. In some embodiments, the plurality of non-contiguous periods of time can comprise first and second periods of time respectively characterized by different weighted averages of spectral wavelengths of visible light in the solar irradiance. In some embodiments, the plurality of non-contiguous periods of time can be selected to increase a difference in the respective weighted averages of spectral wavelengths of the first and second periods of time. In some embodiments, the plurality of non-contiguous periods of time can be selected to maximize a difference in the respective weighted averages of spectral wavelengths of the first and second periods of time. In some embodiments, the plurality of non-contiguous periods of time can be selected so that a difference in the respective weighted averages of spectral wavelengths between the first and second periods of time is greater than a threshold. In some embodiments, the plurality of non-contiguous periods of time can be selected so that a difference in levels of solar irradiance between the first and second periods of time is greater than a threshold. In some embodiments, at least one of the plurality of periods of time can be selected to improve a correlation between a spectral distribution of solar irradiance and a spectral response of the PV modules. In some embodiments, at least one of the plurality of periods of time can be selected to maximize a correlation between a spectral distribution of solar irradiance and a spectral response of the PV modules.

In some embodiments, the calculating of the value of the parameter of the calibration function can be based in part on a weighted average of spectral wavelengths of visible light in the irradiance.

In some embodiments, the non-transient computer-readable medium can additionally store program instructions that, when executed by the one or more processors, cause the one or more processors to identify one or more periods of time as being characterized by clear-sky conditions. In some embodiments, the non-transient computer-readable medium can additionally store program instructions that, when executed by the one or more processors, cause the one or more processors to report a fault in the irradiance sensor, responsively to the calculating of the value of the parameter of the calibration function. In some embodiments, the non-transient computer-readable medium can additionally store program instructions that, when executed by the one or more processors, cause the one or more processors to use the value of the parameter of the calibration function in setting a cleaning schedule of one or more of the PV modules. In some embodiments, the non-transient computer-readable medium can additionally store program instructions that, when executed by the one or more processors, cause the one or more processors to use the value of the parameter of the calibration function in a comparison of electricity production of the solar energy system with a projection based on the received measured values. In some embodiments, the non-transient computer-readable medium can additionally store program instructions that, when executed by the one or more processors, cause the one or more processors to report a possible fault of one or more PV modules responsively to accessing electrical output data of the solar energy system and the calculating of the value of the parameter of the calibration function.

In some embodiments, calculating the value of the parameter of the calibration function can include using a multiplicative factor. In some embodiments, calculating the value of the parameter of the calibration can include using an arithmetic factor to correct for bias in the received measured values. In some embodiments, the calibration function can be time-of-day and/or time-of-year dependent. In some embodiments, the calibration function can compensate for an orientation of the irradiance sensor.

In some embodiments, calculating the value of the parameter of the calibration function can include estimating bias in the received measured values and compensating for said bias.

In some embodiments, a computing arrangement for the solar energy system can be provided with any or all of the abovementioned program instructions.

In some embodiments, a method for calibrating the irradiance sensor of the solar energy system (according to any of the foregoing embodiments) comprises: (a) receiving, from the irradiance sensor, the one or more measured values of solar irradiance for a period of time characterized by clear-sky conditions; (b) accessing the satellite irradiance data for the period of time, for the location including the irradiance sensor; and (c) comparing the one or more received measured values with the accessed satellite data to calculate the calibration function for the irradiance sensor. The receiving, accessing and comparing are carried out by the control system.

A method is disclosed, according to embodiments, for calibrating an irradiance sensor of a solar energy system. According to the method, the solar energy system additionally (in addition to the irradiance sensor) comprises a plurality of photovoltaic (PV) modules and a computing arrangement, and optionally comprises one or more motor assemblies configured to pivot the PV modules through respective orientations. The method comprises: (a) receiving, from the irradiance sensor, a plurality of measured values of solar irradiance for a period of time characterized by clear-sky conditions, (b) accessing satellite irradiance data for the period of time, for a location including the irradiance sensor, and (c) comparing the plurality of received measured values with the accessed satellite data to calculate a calibration function for the irradiance sensor. According to the method, the receiving, accessing and comparing are carried out by the computing arrangement.

In some embodiments, the method can additionally comprise selecting the period of time so as to improve a correlation between a spectral distribution of solar irradiance and a spectral response of the PV modules.

In some embodiments, (i) receiving the plurality of measured values of solar irradiance can include receiving a respective set of measured values for each of a plurality of non-contiguous periods of time, and/or (i) accessing the satellite irradiance data can include accessing satellite irradiance data for each of the plurality of non-contiguous periods of time. In some embodiments, the plurality of non-contiguous periods of time can comprise first and second periods of time respectively characterized by different weighted averages of spectral wavelengths of visible light in the solar irradiance. In some embodiments, the method can additionally comprise selecting the plurality of non-contiguous periods of time so as to increase a difference in the respective weighted averages of spectral wavelengths of the first and second periods of time. In some embodiments, the method can additionally comprise selecting the plurality of non-contiguous periods of time so as to maximize a difference in the respective weighted averages of spectral wavelengths of the first and second periods of time. In some embodiments, the method can additionally comprise selecting the plurality of non-contiguous periods of time so that a difference in the respective weighted averages of spectral wavelengths between the first and second periods of time is greater than a threshold. In some embodiments, the method can additionally comprise selecting the plurality of non-contiguous periods of time so that a difference in levels of solar irradiance between the first and second periods of time is greater than a threshold. In some embodiments, the method can additionally comprise selecting at least one of the plurality of non-contiguous periods of time so as to improve a correlation between a spectral distribution of solar irradiance and a spectral response of the PV modules. In some embodiments, the method can additionally comprise selecting at least one of the plurality of non-contiguous periods of time so as to maximize a correlation between a spectral distribution of solar irradiance and a spectral response of the PV modules.

In some embodiments, the calculating of the calibration function is based in part on a weighted average of spectral wavelengths of visible light in the irradiance.

In some embodiments, the method can additionally comprise identifying one or more periods of time as being characterized by clear-sky conditions.

In some embodiments, the method can additionally comprise using the value of the parameter of the calibration function in a comparison of electricity production of the solar energy system with a projection based on the received measured values.

In some embodiments, the method can additionally comprise reporting a fault in the irradiance sensor, responsively to the calculating of the value of the parameter of the calibration function. In some embodiments, the method can additionally comprise using the value of the parameter of the calibration function in setting a cleaning schedule of one or more of the PV modules. In some embodiments, the method can additionally comprise reporting a possible fault of one or more PV modules responsively to accessing electrical output data of the solar energy system and calculating a value of the parameter of the calibration function.

In some embodiments, calculating the value of the parameter of the calibration function can include using a multiplicative factor. In some embodiments, calculating the value of the parameter of the calibration can include using an arithmetic factor to correct for bias in the received measured values. In some embodiments, the calibration function can be time-of-day and/or time-of-year dependent. In some embodiments, the calibration function can compensate for an orientation of the irradiance sensor.

In some embodiments, calculating the value of the parameter of the calibration function can include estimating bias in the received measured values and compensating for said bias. In some embodiments, the method can additionally comprise projecting electricity production of the solar energy system, using one or more calculated values of the calibration function for the irradiance sensor. In some embodiments, the projecting can include predicting electricity production for a future period. In some embodiments, the projecting can include modeling electricity production for a past period. In some embodiments, it can be that the projecting is improved by using the one or more calculated values of the calibration function for the irradiance sensor.

A method is disclosed, according to embodiments, for calibrating an irradiance sensor of a weather station comprising an irradiance sensor and a computing arrangement. The method comprises: (a) receiving, from the irradiance sensor, a plurality of measured values of solar irradiance for a period of time characterized by clear-sky conditions; (b) accessing satellite irradiance data for the period of time, for a location including the irradiance sensor; and (c) comparing the plurality of received measured values with the accessed satellite data to calculate a calibration function for the irradiance sensor. According to the method, the receiving, accessing and comparing are carried out by the computing arrangement.

### BRIEF DESCRIPTION OF THE DRAWINGS

The invention will now be described further, by way of example, with reference to the accompanying drawings, in which the dimensions of components and features shown in the figures are chosen for convenience and clarity of presentation and not necessarily to scale. In the drawings:

FIG. 1 shows a block diagram of a solar energy system, according to embodiments of the present invention.

FIG. 2 shows a schematic layout of selected components of a solar energy system according to embodiments of the present invention.

FIG. 3 shows a block diagram of a control system for a solar energy system, according to embodiments of the present invention.

FIG. 4A shows a block diagram relating to inputs to a control system, according to embodiments of the present invention.

FIG. 4B shows components of an exemplary weather station, according to embodiments of the present invention.

FIG. 5 is a schematic illustration of a PV module exposed to different components of solar irradiance, according to embodiments of the present invention.

FIG. 6 shows a flowchart of a method for calibrating the irradiance sensor of a weather station, according to embodiments of the present invention.

FIGS. 7A, 7B, 7C, 7D, 7E, 7F, 7G, 7H, 7I, 7J, 7K, 7L, 7M and 7N show flowcharts of a method and method steps for calibrating the irradiance sensor of a solar energy system, according to embodiments of the present invention.

FIGS. 8A, 8B, 8C, 9A, 9B and 9C show schematically drawn graphs of satellite data versus measurements from various irradiance sensors for different seasons, according to embodiments of the present invention.

FIG. 10A is a graph of relative irradiance as a function of wavelength for different times of a day.

FIG. 10B is a graph of the spectral response of an exemplary PV cell.

### DETAILED DESCRIPTION OF THE ILLUSTRATED EMBODIMENTS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. Throughout the drawings, like-referenced characters are generally used to designate like elements.

Embodiments disclosed herein relate to calibration of irradiance sensors. In some embodiments, the irradiance sensors are used in conjunction with solar energy systems that comprise arrays of photovoltaic (PV) panels to produce electricity. In some embodiments, such solar energy systems can include one or more irradiance sensors, along with other ‘weather station’ instruments such as sky-facing cameras and meteorological instruments not directly related to solar radiation, such as, and not exhaustively, temperature and humidity gauges.

As is known in the art, several types of irradiance sensors can be suitable for use in connection with the disclosed embodiments. Pyranometers measure the total solar radiation (both direct and diffuse) on a horizontal surface. They are often used to monitor the overall solar resource available to a PV array. Plane of Array (POA) Pyranometers are specifically designed to measure the solar radiation on the plane of the PV array itself. They may provide a more accurate measurement of the irradiance that the PV panels are actually receiving. Reference Cells are photovoltaic cells that are used to measure the solar irradiance in a manner similar to the PV panels themselves. They help in accurately assessing the performance of the PV array by providing irradiance data that closely matches the actual conditions experienced by the panels. Spectroradiometers measure the solar radiation across the entire electromagnetic spectrum, and can provide detailed spectral information that can be useful when it is desirable for measuring irradiance as a function of spectral wavelength, or, for example, computing a weighed average, i.e., weighted by actual irradiance, of spectral wavelengths for a given time period.

In some embodiments, a weather station including an irradiance sensor or a standalone irradiance sensor can be used in conjunction with multiple PV arrays that are either co-located or located in proximity to each other. Measurements from such irradiance sensors can be used for one or more objectives related to the operation of a solar energy system. A ‘solar energy system’ as used herein means a system for generating electricity using an array of photovoltaic (PV) panels. The system can optionally include a motor and appropriate mechanical arrangements for pivoting the array to track the sun during the course of the day and thus increase electricity production in comparison with static systems. The system can include an inverter for converting the direct-current (DC) electricity generated by the PV modules to alternating current (AC) electricity, e.g., for delivery to an electricity grid. The system can also include a control system programmed or programmable to control the operation of the solar energy system, including the operation of the tracking motor. In some applications, irradiance sensors deployed in conjunction with solar energy systems are used for comparing or correlating system performance, i.e., electricity production, with actual insolation over a period of time. In some applications, irradiance sensors deployed in conjunction with solar energy systems are used for selecting a preferred orientation of the PV panels, for example, during periods of reduced insolation. In some applications, it can be important to know whether a reduction in irradiance measurements received from an irradiance sensor is due to the presence of dirt on the sensor or the sensor being out of alignment. In some applications, irradiance sensors are used in scheduling cleaning for the PV panels of the solar energy system, e.g., based on an estimated level of dirt, dust and organic contaminants based, inter alia, on reduced remote readings from the irradiance sensor during period of time that are presumed to be ‘clear-sky’ periods. A clear-sky period is one in which there are no clouds, or minimal clouds, obscuring the sun such that response of an irradiance sensor or PV panel is presumed to be unaffected by clouds.

In some embodiments, the irradiance sensors are deployed remotely but not in conjunction with the operation of solar energy systems. In an illustrative example, irradiance sensors can be deployed at locations being considered as sites for building future solar energy systems, e.g., in order to accrue information regarding irradiance characteristics of the sites.

On-site and/or manual assessment of the calibration of irradiance sensors, including potential mechanical misalignment and/or dirt buildup, can be costly and logistically complicated. Therefore, in embodiments disclosed herein, the state of irradiance sensors can be remotely ascertained, and the sensors can be ‘algorithmically calibrated’ either automatically by the software of a weather station or of a control system associated with a solar energy system, or with user supervision of the software. ‘Algorithmically calibrated’ means that instead of physically cleaning a dirty sensor or realigning a misaligned sensor, the readings from such a sensor can be ‘corrected’ in the software of a weather station or control system of a solar energy system to reduce or eliminate the effects of the dirt buildup and/or misalignment.

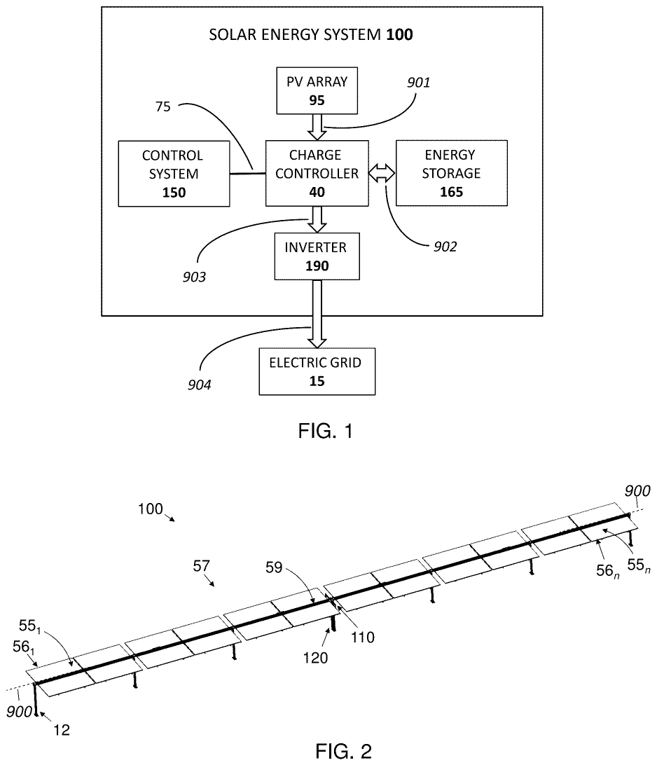

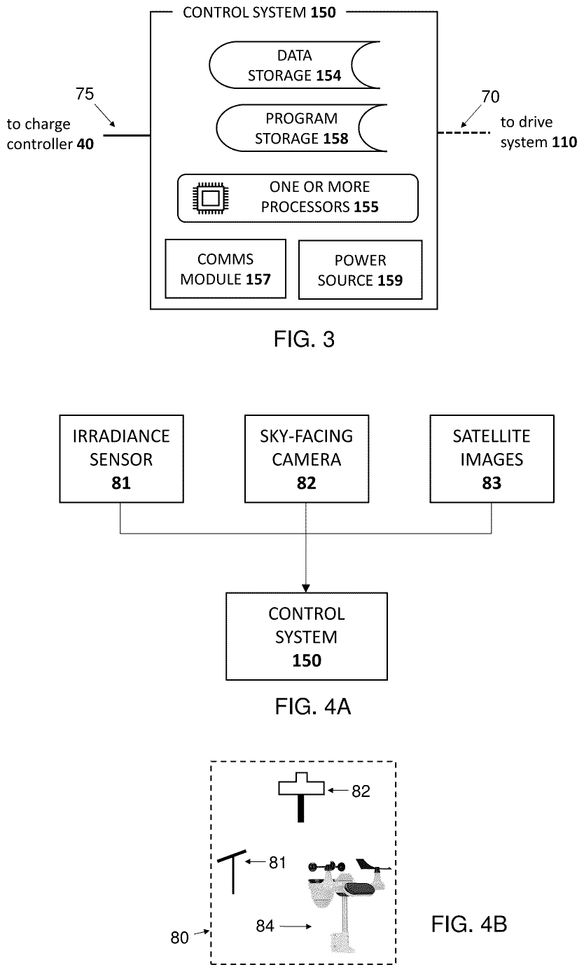

Referring now to the figures, and in particular to FIG. 1, a solar energy system 100 according to embodiments includes a PV array 95 comprising a plurality of PV modules 57 (shown in FIG. 2). In embodiments, the modules 57 of the PV array 95 includes a tracking component, i.e., a solar tracker, for increasing cumulative electricity generated over the course of a period of time.

A solar tracker, or simply ‘tracker’, is an arrangement that changes the orientation of the PV panels in response to commands from a controller. Whenever direct solar irradiance is available, the tracker is oriented and incrementally pivoted so as to capture, i.e., convert, the highest possible proportion of the direct irradiance falling on the panels over the course of nearly any given period of time. In some instances, the tracker is oriented to capture and convert energy up to a given maximum or setpoint. Capture and conversion of the diffuse radiation component of the incident solar irradiance is considerably smaller than that of the direct component, and therefore the tracking is largely unaffected by distribution of diffuse radiation. In embodiments, a pyranometer is often chosen as an irradiance sensor in connection with a solar tracker system.

A single-axis tracker is one that rotates PV panels around a single axis, usually rotating from facing east to facing west over the course of a day around a north-south axis. A double-axis, or two-axis, tracker is one that is designed to generally have the PV panels ‘face’ the sun directly at all times so as to capture and convert as much energy as possible from available direct irradiance by reducing the angle between a normal vector of the PV panels and incident direct irradiance to zero, or substantially zero, in not just one plane but all planes. Some double-axis trackers operate using Euler angles and do not, strictly speaking, rotate the PV panels about two Cartesian axes, but the results are substantially the same. The embodiments disclosed herein are described in terms of single-axis tracking, but their application, mutatis mutandis, to double-axis tracking, is within the scope of the present invention.

The solar system 100 of FIG. 1 additionally includes an inverter 190 for conversion of DC electricity to AC. An inverter can include electronic circuitry, for example for synchronizing the phase, and for matching the voltage and frequency of the power output to those of the grid.

FIG. 1 further illustrates a non-limiting example of a power flow scheme for a solar energy system 100: power generated by the PV array 95 flows to a charge controller 40 as indicated by arrow 901. Two-way power flow takes place between the charge controller 40 and an energy storage device 165, as indicated by two-way arrow 902. Power from the PV array 95 and the energy storage device 165 flows through the charge controller 40 to the inverter 190, as indicated by arrow 903. The inverter 190 can deliver energy to the electric grid 15, as indicated by arrow 904.

Referring now to FIG. 2, a solar energy system 100 according to embodiments includes a PV assembly 57 comprising an array of n PV panels 55₁ through 55ₙ respectively joined to an array of n frames 56₁ through 56ₙ. A frame assembly includes the frames 56 and a central elongated member 59 to which the frames 56 are joined. If the solar energy system 100 includes solar tracking and rotation of PV modules, the central elongated member 59 serves to transfer a torque, e.g., from an electric motor, to rotate the PV assembly 57, i.e., the frames 56 as a unit, together with the central elongated member 59 and the PV panels 55. The PV assembly 57 in a tracking system rotates about a central longitudinal axis schematically indicated in FIG. 1 by line 900. The central elongated member 59 is supported, e.g., pivotably supported, by multiple ground supports 12 and by a central support pylon 120 at which a drive system 110 of the solar energy system 100 is installed. In examples, the drive system 110 transfers torque to the frame subassembly at a single location along the length of the central elongated member 59, and in such examples the drive system 110 is located at or adjacent to the midpoint of the central elongated member 59.

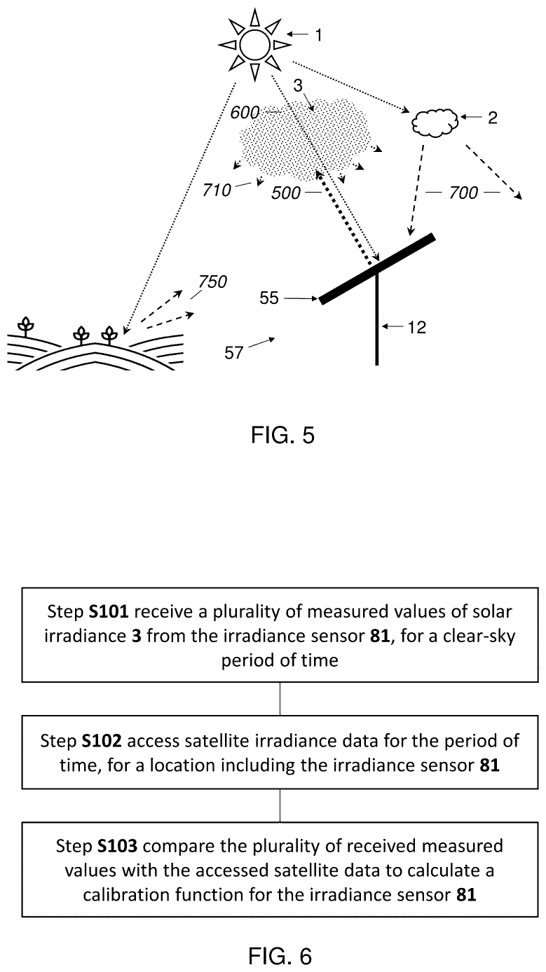

In embodiments, a computing arrangement associated comprising a control system 150, (also called a ‘controller’) for a solar energy system 100, according to embodiments, is illustrated in the block diagram of FIG. 3 to show selected components. The exemplary control system 150 of FIG. 3 includes one or more computer processors 155, a computer-readable storage medium 158, a communications module 157, and a power source 159. The computer-readable storage medium 158 can include transient and/or transient storage, and can include one or more storage units, all in accordance with desired functionality and design choices. The storage 158 can be used for any one or more of: storing program instructions, in firmware and/or software, for execution by the one or more processors 155 of the control system 150. In embodiments, the stored program instructions include program instructions for operating a solar energy system 100 or a weather station 80 in accordance with any of the embodiments disclosed herein. Data storage 154, if separate from storage 158, can be provided for historical data, e.g., actual irradiance and/or forecast values, e.g., forecasted irradiance values, and other data related to the operation of the solar energy system 100. In some embodiments, the two storage modules 154, 158 form a single module. The communications module 159 is configured to establish communications links, e.g., via communication arrangements 70 with a forecasting module or system 200 (described below and illustrated schematically in FIG. 3), and with the charge controller 40 via communications arrangements 75. In some embodiments, a control system 150 does not necessarily include all of the components shown in FIG. 2. The terms “communications arrangements” or similar terms such as “communications links” as used herein mean any wired connection or wireless connection via which data communications can take place. Non-limiting and non-exhaustive examples of suitable technologies for providing communications arrangements include any short-range point-to-point communication system such as IrDA, RFID (Radio Frequency Identification), TransferJet, Wireless USB, DSRC (Dedicated Short Range Communications), or Near Field Communication; wireless networks (including sensor networks) such as: ZigBee, EnOcean; Wi-fi, Bluetooth, TransferJet, or Ultra-wideband; and wired communications bus technologies such as. CAN bus (Controller Area Network, Fieldbus, FireWire, HyperTransport and InfiniBand.

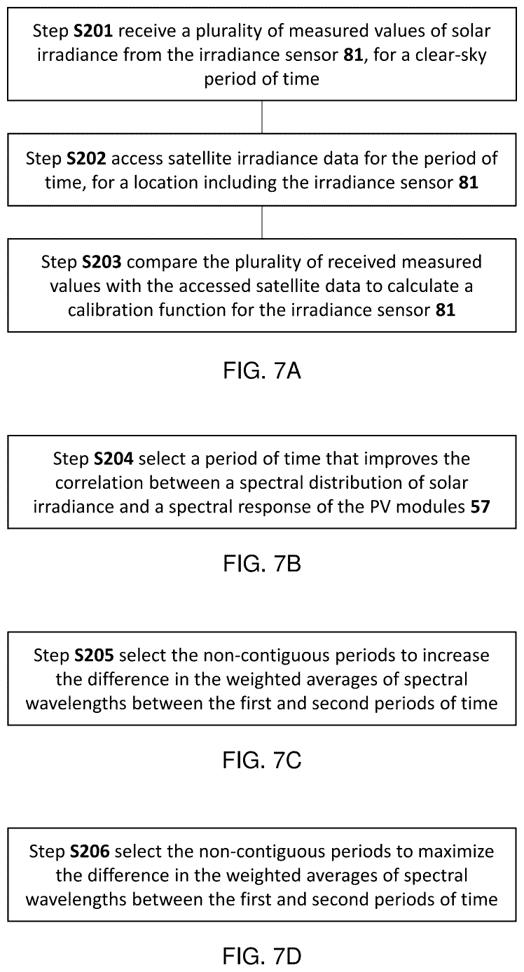

In embodiments, it can be desirable to access forecasted meteorological data and other sensor data, e.g., for predicting the intensity of the various components of solar radiance and calculating therefrom electrical output of a PV array for an imminent future time period, e.g., a future time period beginning immediately following the time of the forecasting. In an example, the forecasting and predicting can be calculated using and/or on the basis of images captured by a sky-facing optical sensor, e.g., a sky-facing camera. A sky-facing camera can capture images of the sky over the solar energy system, including multiple successive images that can be used, e.g., to interpret movements of clouds. FIG. 4A shows examples of components, according to embodiments, provided for working with a short-term forecasting module or system 200. The non-exhaustive list of components includes one or more irradiance sensors 81, sky-facing optical sensors 82, and a source of satellite imagery 83. In some embodiments, the one or more irradiance sensors 81 and the sky-facing optical sensors 82 can be part of a weather station 80 that includes additionally meteorological instruments, as shown in FIG. 4B. In some embodiments, the weather station 80 can be located at, adjacent to, or within a solar energy system 100. In some embodiments, the weather station 80 can be remotely located from a solar energy system 100 or even have no connection to a solar energy system. In some embodiments, the one or more irradiance sensors 81 and the sky-facing optical sensors 82 can be installed at, adjacent to, or within a solar energy system 100 and not as part of a weather station that includes additional meteorological instruments.

FIG. 4B schematically shows selected components of a weather station 80 according to embodiments. The exemplary weather station 80 of FIG. 4B shows an irradiance sensor 81, a sky-facing camera 82, and an off-the-shelf ‘meteo station’ comprising meteorological instrumentation such as is used for measuring wind velocity and direction, humidity and/or temperature.

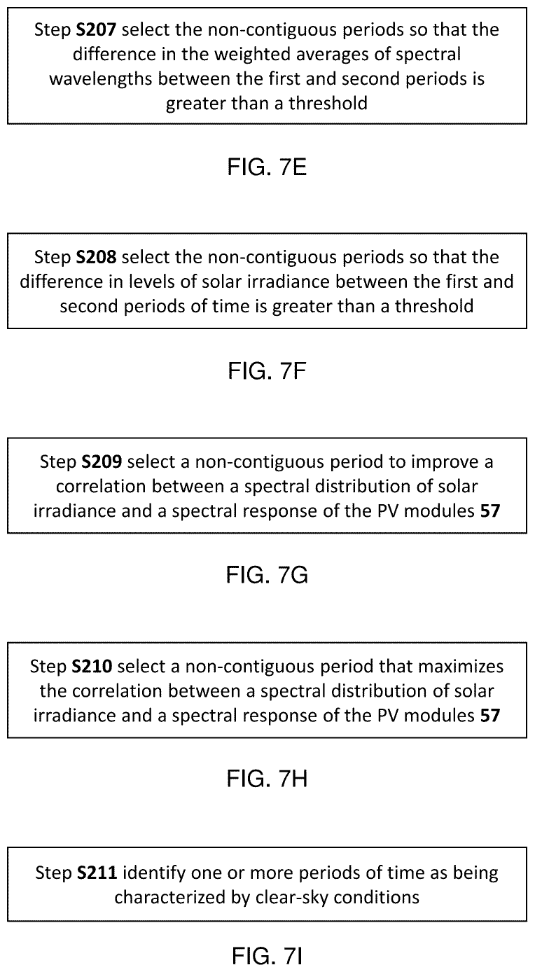

FIG. 5 illustrates the various components of solar irradiance with reference to a PV array. The module 57 is drawn schematically as an end view showing the ground support 12 and the PV panels 55. In the illustration of FIG. 5, the PV module 57 is oriented on-sun, i.e., faces the sun 1 directly on at least one axis, and thus the direct component 600 impinges upon the surface of the panels 55 at a right angle to the panels 55, i.e., the angle between the direct component 600 and a normal vector 500 of the panels 55 is zero, or substantially zero, or substantially zero in at least one plane. In a plane orthogonal to the illustrated plane of the figure, the vector 500 may or may not be parallel to the vector of the direct component 600 in a single-axis tracking system. Some of the direct radiation 600 of FIG. 5 reaches clouds 2 and the fraction that is not absorbed is scattered and further propagated as diffuse radiation 700. The direct irradiance 600, even in the absence of clouds, passes through particulate matter 3 in the atmosphere including, e.g., dust, water vapor, organic matter, etc., and a portion of the irradiation, e.g., 1-15%, or 5-10%, is scattered as diffuse radiation 710. Yet another type, or component, of diffuse radiation is reflected solar energy (albedo), shown in FIG. 5 as reflected off the surrounding landscape by diffuse radiation 750. Some PV modules have panel panels on the ‘back side’ as well in order to convert additional solar radiation to electricity, e.g., reflected and diffused radiation 750. Thus, the diffuse component of solar irradiance as discussed hereinbelow can include any combination of cloud-diffused radiation 700, particulate-diffused radiation 710, and reflected radiation 750.

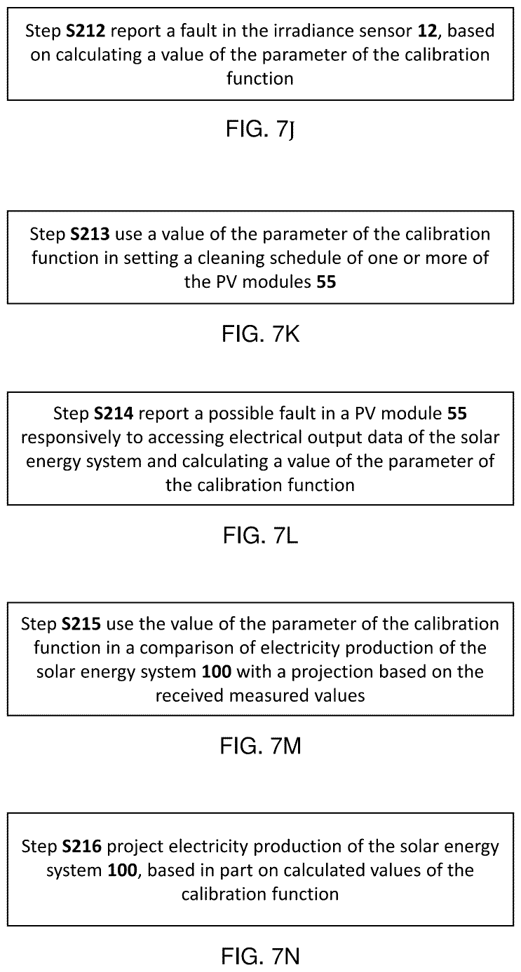

Referring now to FIG. 6, a method is disclosed for calibrating an irradiance sensor 81 of a weather station 80. According to the method, the weather station comprises an irradiance sensor 81 and a computing arrangement 150. As illustrated by the flow chart in FIG. 6, the method comprises at least the three method steps S101, S102 and S103.

Step S101 includes receiving, from the irradiance sensor 81, a plurality of measured values of solar irradiance for a period of time that is characterized by clear-sky conditions.

Step S102 includes accessing satellite irradiance data 83 for the period of time, i.e., the same clear-sky period of time mentioned of Step S01, for a location including the irradiance sensor 81.

Step S103 includes comparing the plurality of received measured values of solar irradiance with the accessed satellite data, to calculate a calibration function for the irradiance sensor 81, e.g., to calculate the value of a parameter of a calibration function According to embodiments, the calibration function is calculated when the comparing yields a discrepancy between the measurements from the irradiance sensor and the satellite data. Non-limiting examples of calibration function parameters include multiplicative factors, offset factors, measurement bias factors, and any combination thereof.

According to the method, the receiving, accessing and comparing of Steps S101, S102 and S103, respectively, are carried out by the control system 150.

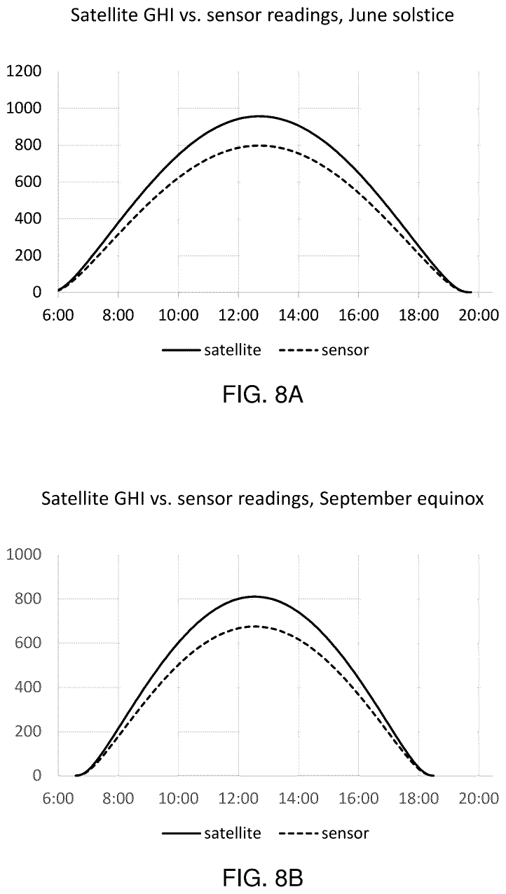

Referring now to FIG. 7A, a method is disclosed for calibrating an irradiance sensor 81 of a solar energy system 100. According to the method, the solar energy system comprises, i.e., in addition to the irradiance sensor 81, a plurality of photovoltaic (PV) modules 57 and, optionally, one or more motor assemblies configured to pivot the PV modules 57 through respective orientations, and a control system 150. As illustrated by the flow chart in FIG. 7A, the method comprises at least the three method steps S201, S202 and S203.

Step S201 includes receiving, from the irradiance sensor 81, a plurality of measured values of solar irradiance for a period of time that is characterized by clear-sky conditions.

Step S202 includes accessing satellite irradiance data 83 for the period of time, i.e., the same clear-sky period of time mentioned of Step S01, for a location including the irradiance sensor 81.

Step S203 includes comparing the plurality of received measured values of solar irradiance with the accessed satellite data, to calculate a value of a parameter of a calibration function for the irradiance sensor 81. According to embodiments, the calibration function is calculated when the comparing yields a discrepancy between the measurements from the irradiance sensor and the satellite data. In some embodiments, Step S203 includes estimating bias in the received measured values and compensating for said bias.

In some embodiments, the receiving, accessing and comparing of Steps S201, S202 and S203, respectively, are carried out by the control system 150.

The content of Steps S201, S202 and S203 is the same as the content of Steps S101, S102 and S103, respectively. Steps S101, S102 and S103, as noted above, are carried out in the context of a irradiance sensor 81 that is part of a weather station 80, regardless of any possible relation to a solar energy system. Steps S201, S202 and S203 are carried out in the context of a irradiance sensor 81 that is part of a solar energy system 100 regardless of whether the solar energy system 100 comprises a full weather station 80. Therefore, while the following discussion of optional features and the content of additional Steps S204 . . . S215 relates to the irradiance sensor 81 of a solar energy system 100 and Steps S201, S202 and S203, the optional features and the content of Steps S204 . . . S212 are fully applicable, mutatis mutandis, to the irradiance sensor 81 of a weather station 80 and Steps S101, S102 and S103., while Steps S213, S215 and S214 relate specifically to an irradiance sensor deployed in conjunction with, or as part of, a solar energy system 100.

As discussed above, the state of irradiance sensors can be remotely ascertained, and the sensors can be ‘algorithmically calibrated’ by the software of a weather station or of a control system associated with a solar energy system. In some embodiments, the algorithmic calibration is performed automatically following calculation of a calibration function in Step S203. In some embodiments, the algorithmic calibration is carried out after user intervention, e.g., remote intervention, after the calculation is reviewed or verified.

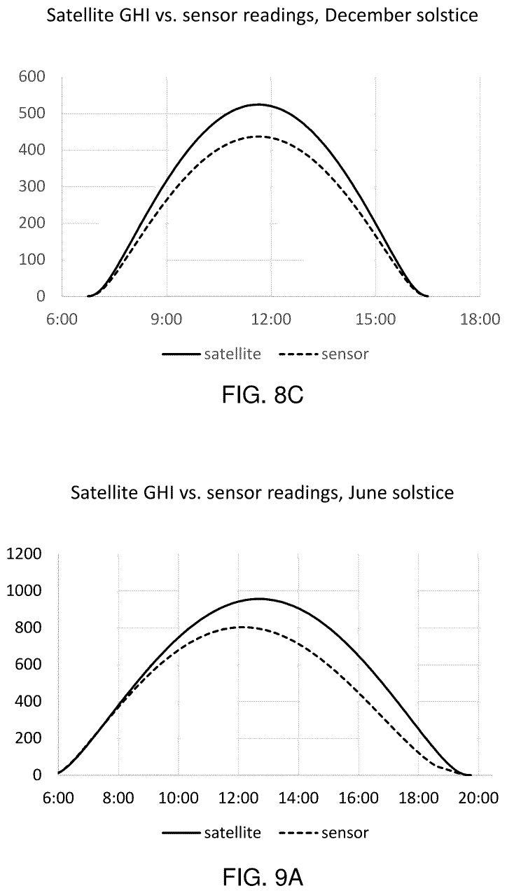

In embodiments, calculating a calibration function, e.g., calculating a value of a parameter of a calibration function, can include determining the nature of a problem causing the need for calibration. It some applications, it is possible to define two major categories of problems. The first category includes loss of calibration due to accumulations of dirt, dust, organic matter and/or other contaminants on the sun-facing surface of the sensor. FIGS. 8A, 8B and 8C are useful in illustrating how the software of the weather station or solar energy system can determine that a discrepancy between the sensor data received in Step S201 and the satellite data accessed in Step S202 is due to a problem of the first category of problem. The three graphs shown in FIGS. 8A, 8B and 8C show plots of respective sensor measurements and satellite data for an idealized location in the northern hemisphere, respectively at the June solstice, the September equinox, and the December solstice. An obvious characteristic of the three graphs is that for each graph, i.e., each day, the plot of sensor measurements has values lower than corresponding values of the plot of satellite data, and in an even, near-proportional manner. This type of graph, and especially the symmetrical and proportional characteristics of the discrepancy in values showing that all times of day and all seasons are similarly affected, may indicate to the skilled artisan, as well as to the control system software carrying out the method steps, that the root cause of the discrepancy is fouling of the sensor, e.g., by dirt. Thus, in some embodiments, calculating the calibration function can include deriving or using a multiplicative factor, as can be understood from the graphs in FIGS. 8A, 8B and 8C. In some embodiments, calculating the value of the parameter of the calibration function can include using an arithmetic factor to correct for bias in the received measured values.

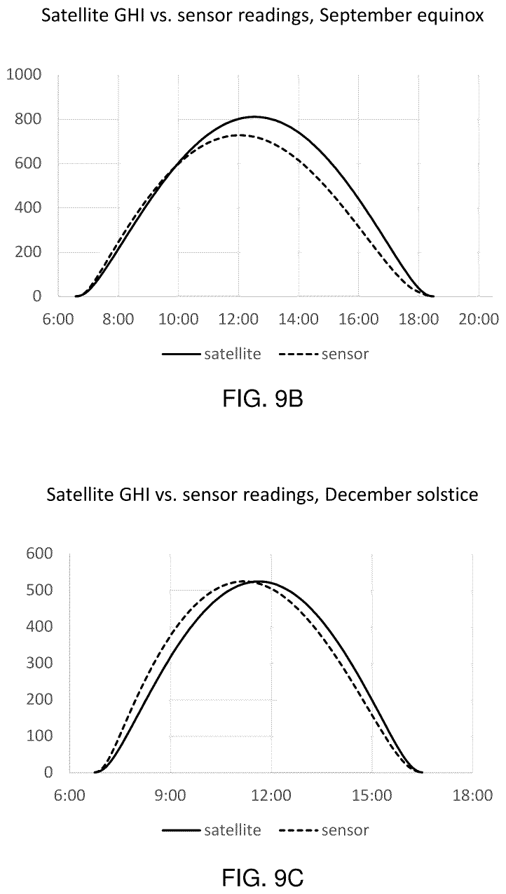

In contradistinction, FIGS. 9A, 9B and 9C, which also show plots of respective sensor measurements and satellite data for an idealized location in the northern hemisphere, respectively at the June solstice, the September equinox, and the December solstice, indicate a discrepancy due to a second category of problem: a sensor being out of alignment. In most implementations, a common type of misalignment is a tilted that pushes measurements visibly out of phase with the satellite data, such that the daily peak values measured by the scanner do not align with the daily peak data points in the satellite data. As can be seen in the graphs, the discrepancy shifts from season to season as the sun position (e.g., azimuth) shifts, such that in summer (FIG. 9A), the sensor readings remain lower than the satellite data throughout the day, while in both autumn and winter (FIGS. 9B and 9C, respectively) the irradiance sensor readings are higher than the satellite data in the morning and lower in the afternoon. This type of graph, and especially the shifting of the respective plots, indicate to the skilled artisan, as well as to the control system software carrying out the method steps, that the root cause of the discrepancy is a physical misalignment of the irradiance sensor, e.g., a tilted orientation. In some embodiments, the calculation of a calibration function based on a such problem of the second category and the implementation of the algorithmic calibration can evolve across seasons as the seasonal change in the discrepancy makes the exact nature of the problem clearer. Thus, in some embodiments, the calibration function is time-of-day and/or time-of-year dependent. In some embodiments, the control system is programmed or programmable to interpret a set of graphs which singly or in combination indicate the effects of both categories of calibration problems, i.e., dirt buildup and physical misalignment.

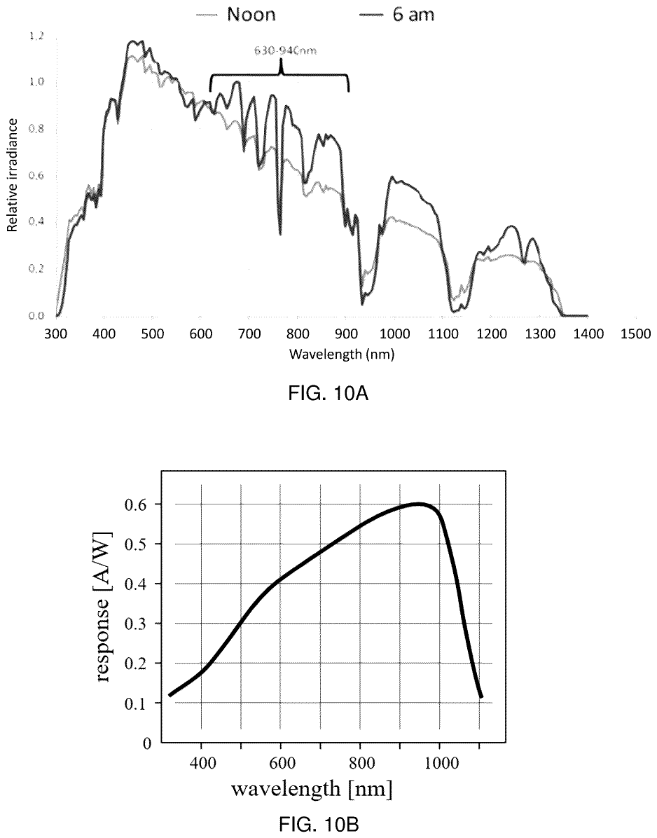

In embodiments, it can be desirable to carry out the steps of the method in a manner that reduces or even eliminates bias introduced when not taking into account the spectral distribution of solar irradiance and the spectral response of the PV modules 57 when carrying out steps S201, S202 and S203. In some embodiments, the method additionally comprises Step S204. As illustrated in the flow chart of FIG. 7B, Step S204 includes selecting the period of time so as to improve a correlation between a spectral distribution of solar irradiance and a spectral response of the PV modules 57. The wavelength of the solar spectrum reaching the Earth's surface varies throughout the day due to several factors, including the angle of the sun, atmospheric scattering, and absorption. During sunrise and sunset, the sun is low on the horizon, and its light passes through a thicker layer of the Earth's atmosphere. This causes more scattering of shorter wavelengths corresponding to blue and violet light, and increases the relative presence of longer wavelengths, corresponding to red, orange, and yellow light, in incident irradiance. In contrast, around midday, sunlight travels through a shorter path in the atmosphere, and as a result, there is less scattering of shorter wavelengths. FIG. 10A is an illustrative graph created for an idealized location and day of the year, showing relative irradiance in W/m² for 6 am and 12 noon. The graph shows that the intensity of light in higher wavelengths in the morning is much greater than at midday. This is particularly prominent, as annotated, in the range of about 630-940 nm, which includes red light and near-infrared (NIR). The spectral response of a PV cell is a function of its cell chemistry. FIG. 10B shows the spectral response in terms of photovoltaic current A per watt (W) of irradiance. The graph in FIG. 10B shows a higher spectral response in the higher wavelength, including, for example, the range noted with respect to FIG. 10A including red and NIR light. In embodiments, carrying out Step S204 thus involves aligning the time period of Steps S201 and S202 with the spectral response of the cell chemistry of the PV modules 57 when carrying out the comparing and calculating of Steps S203. In an example, carrying out Step S204 is effective to reduce or eliminate bias related to the spectral distribution of solar irradiance and/or the spectral response of the PV modules 57. In some embodiments, the calculating of the calibration function is based in part on a weighted average of spectral wavelengths of visible light in the irradiance.

In some embodiments, the plurality of measured values of solar irradiance received in Step S201 are for a plurality of non-contiguous periods of time, and thus receiving the plurality of measured values of solar irradiance includes receiving a respective set of measured values for each of a plurality of non-contiguous periods of time. Accessing the satellite irradiance data can includes accessing satellite irradiance data for each of the plurality of non-contiguous periods of time for which measured values are received. In a non-limiting example, the received values correspond to early morning hours and late afternoon hours. In the example, the accessed satellite irradiance data is for the plurality of non-contiguous periods of time. In some embodiments, an exemplary plurality of non-contiguous periods of time can comprise first and second periods of time respectively characterized by different weighted averages of spectral wavelengths of visible light in the solar irradiance; in a non-limiting example, the received values correspond to early morning hours and early afternoon hours starting at solar noon. In some embodiments, the method additionally comprises Step S205. As illustrated in the flow chart of FIG. 7C, Step S205 includes selecting the plurality of non-contiguous periods of time so as to increase a difference in the respective weighted averages of spectral wavelengths of the first and second periods of time. In some embodiments, the method additionally comprises Step S206. As illustrated in the flow chart of FIG. 7D, Step S206 includes selecting the plurality of non-contiguous periods of time so as to maximize a difference in the respective weighted averages of spectral wavelengths of the first and second periods of time. In some embodiments, the method additionally comprises Step S207. As illustrated in the flow chart of FIG. 7E, Step S207 includes selecting the plurality of non-contiguous periods of time so that a difference in the respective weighted averages of spectral wavelengths between the first and second periods of time is greater than a threshold.

In embodiments, it can be desirable to carry out the steps of the method in a manner that reduces or even eliminates bias introduced when not taking into account the relative intensity levels of irradiance when carrying out steps S201, S202 and S203. By taking instantaneous irradiance into account in order, one may arrive at a more precise calibration function. In some embodiments, the method additionally comprises Step S208. As illustrated in the flow chart of FIG. 7F, Step S208 includes selecting the plurality of non-contiguous periods of time so that a difference in levels of solar irradiance between the first and second periods of time is greater than a threshold.

In some embodiments, the method additionally comprises Step S209. As illustrated in the flow chart of FIG. 7G, Step S209 includes selecting at least one of the plurality of non-contiguous periods of time so as to improve a correlation between a spectral distribution of solar irradiance and a spectral response of the PV modules 57. In some embodiments, the method additionally comprises Step S210. As illustrated in the flow chart of FIG. 7H, Step S210 includes selecting at least one of the plurality of non-contiguous periods of time so as to maximize a correlation between a spectral distribution of solar irradiance and a spectral response of the PV modules 57. Steps S209 and S210 differ from Steps S204 and S205, respectively, in that Steps S04 and S205 include selecting a single time period for carrying out Step S201, whilst Steps S209 and S210 include selecting at least one of a plurality of non-contiguous time periods for carrying out Step S201.

As discussed above, the method is to be carried out for periods of time characterized by clear-sky conditions. In some embodiments, the method additionally comprises Step S211, which, as illustrated in the flow chart of FIG. 7I, includes identifying one or more periods of time as being characterized by clear-sky conditions.

In some embodiments, the method additionally comprises Step S212. As illustrated in the flow chart of FIG. 7J, Step S212 includes reporting a fault in the irradiance sensor, responsively to the calculating of the value of the parameter of the calibration function in Step S203. The reporting can be to another computer, to a user, or to any person or body responsible for maintenance.

In some embodiments, calculating the calibration function includes using a multiplicative factor, e.g., to compensate for the accumulation of dirt and other fouling on the irradiance sensor 81. In some such embodiments, the method additionally comprises Step S213. As illustrated in the flow chart of FIG. 7K, Step S213 includes using the value of the parameter of the calibration function in setting a cleaning schedule of one or more of the PV modules. In some embodiments, the calibration function compensates for an orientation of the irradiance sensor.

In some embodiments, the method additionally comprises Step S214. As illustrated in the flow chart of FIG. 7L, Step S214 includes reporting a possible fault of one or more PV modules responsively to accessing electrical output data of the solar energy system and calculating the value of the parameter of the calibration function.

In some embodiments, the method additionally comprises Step S215. As illustrated in the flow chart of FIG. 7M, Step S215 includes using the value of the parameter of the calibration function in a comparison of electricity production of the solar energy system 100 with a projection based on the received measured values.

In some embodiments, the method additionally comprises Step S216. As illustrated in the flow chart of FIG. 7N, Step S216 includes projecting electricity production of the solar energy system 100, using one or more calculated values of the calibration function for the irradiance sensor.

In some embodiments, Step S216 includes comparing the improved actual electricity production by the solar energy system 100 for a time period with the improved predictions for the same period. In some embodiments, the projecting includes predicting electricity production for a future period. In some embodiments, the projecting includes modeling electricity production for a past period. In some embodiments, the projecting is improved by using the one or more calculated values of the calibration function for the irradiance sensor.

In embodiments, any or all of the method steps enumerated above can be carried out by the control system 150. In some such embodiments, the program instructions for carrying out any or all of the enumerated method steps can be stored in non-transient program storage memory 158 and executed by the one or more processors 155. In some embodiments of the method, not all of the steps are carried out. In some embodiments of the control system, not all of the method steps have corresponding program instructions stored in the non-transient program storage memory 158.

The present invention has been described using detailed descriptions of embodiments thereof that are provided by way of example and are not intended to limit the scope of the invention. The described embodiments comprise different features, not all of which are required in all embodiments of the invention. Some embodiments of the present invention utilize only some of the features or possible combinations of the features. Variations of embodiments of the present invention that are described and embodiments of the present invention comprising different combinations of features noted in the described embodiments will occur to persons skilled in the art to which the invention pertains.

1. A weather station comprising:
a. an irradiance sensor; and
b. a computing arrangement comprising one or more processors and a non-transient computer-readable medium storing program instructions that, when executed by the one or more processors, cause the one or more processors to:
i. receive, from the irradiance sensor, a plurality of measured values of solar irradiance for a period of time characterized by clear-sky conditions,
ii. access satellite irradiance data for the period of time, for a location including the irradiance sensor, and
iii. compare the plurality of received measured values with the accessed satellite data to calculate a value of a parameter of a calibration function for the irradiance sensor.

2. The weather station of claim 1, wherein the period of time is selected to improve a correlation between a spectral distribution of solar irradiance and a target spectral response of the PV modules.

3. The weather station of claim 1, wherein the plurality of received measured values of solar irradiance are for a plurality of non-contiguous periods of time, and the accessed satellite irradiance data is for the plurality of non-contiguous periods of time.

4. The weather station of claim 3, wherein the plurality of non-contiguous periods of time comprises first and second periods of time respectively characterized by different weighted averages of spectral wavelengths of visible light in the solar irradiance.

5. The weather station of claim 4, wherein the plurality of non-contiguous periods of time are selected to increase a difference in the respective weighted averages of spectral wavelengths of the first and second periods of time.

6. The weather station of claim 4, wherein the plurality of non-contiguous periods of time are selected to maximize a difference in the respective weighted averages of spectral wavelengths of the first and second periods of time.

7. The weather station of claim 4, wherein the plurality of non-contiguous periods of time are selected so that a difference in the respective weighted averages of spectral wavelengths between the first and second periods of time is greater than a threshold.

8. The weather station of any one of claims 4 to 7, wherein the plurality of non-contiguous periods of time are selected so that a difference in levels of solar irradiance between the first and second periods of time is greater than a threshold.

9. The weather station of any one of claims 3 to 8, wherein at least one of the plurality of periods of time is selected to improve a correlation between a spectral distribution of solar irradiance and a target spectral response.

10. The weather station of any one of claims 3 to 8, wherein at least one of the plurality of periods of time is selected to maximize a correlation between a spectral distribution of solar irradiance and a target spectral response.

11. The weather station of any one of the preceding claims, wherein the calculating of the value of the parameter of the calibration function is based in part on a weighted average of spectral wavelengths of visible light in the irradiance.

12. The weather station of any one of the preceding claims, wherein the non-transient computer-readable medium additionally stores program instructions that, when executed by the one or more processors, cause the one or more processors to identify one or more periods of time as being characterized by clear-sky conditions.

13. The weather station of any one of the preceding claims, wherein the non-transient computer-readable medium additionally stores program instructions that, when executed by the one or more processors, cause the one or more processors to report a fault in the irradiance sensor, responsively to the calculating of the value of the parameter of the calibration function.

14. The weather station of any one of the preceding claims, wherein calculating the value of the parameter of the calibration function includes using a multiplicative factor.

15. The weather station of any one of the preceding claims, wherein calculating the value of the parameter of the calibration includes using an arithmetic factor to correct for bias in the received measured values.

16. The weather station of any one of the preceding claims, wherein the calibration function is time-of-day and/or time-of-year dependent.

17. The weather station of any one of the preceding claims, wherein the calibration function compensates for an orientation of the irradiance sensor.

18. The weather station of any one of the preceding claims, wherein calculating the value of the parameter of the calibration function includes estimating bias in the received measured values and compensating for said bias.

19. The computing arrangement according to any one of the preceding claims.

20. A solar energy system comprising the weather station of any one of claims 1 to 18, and a plurality of photovoltaic (PV) modules.

21. A solar energy system, comprising:
a. a plurality of photovoltaic (PV) modules;
b. an irradiance sensor; and
c. a control system comprising one or more processors and a non-transient computer-readable medium storing program instructions that, when executed by the one or more processors, cause the one or more processors to:
i. receive, from the irradiance sensor, a plurality of measured values of solar irradiance for a period of time characterized by clear-sky conditions,
ii. access satellite irradiance data for the period of time, for a location including the irradiance sensor, and
iii. compare the plurality of received measured values with the accessed satellite data to calculate a calibration function for the irradiance sensor.

22. The solar energy system of claim 21, wherein the period of time is selected to improve a correlation between a spectral distribution of solar irradiance and a spectral response of the PV modules.

23. The solar energy system of claim 21, wherein the plurality of received measured values of solar irradiance are for a plurality of non-contiguous periods of time, and the accessed satellite irradiance data is for the plurality of non-contiguous periods of time.

24. The solar energy system of claim 23, wherein the plurality of non-contiguous periods of time comprises first and second periods of time respectively characterized by different weighted averages of spectral wavelengths of visible light in the solar irradiance.

25. The solar energy system of claim 24, wherein the plurality of non-contiguous periods of time are selected to increase a difference in the respective weighted averages of spectral wavelengths of the first and second periods of time.

26. The solar energy system of claim 24, wherein the plurality of non-contiguous periods of time are selected to maximize a difference in the respective weighted averages of spectral wavelengths of the first and second periods of time.

27. The solar energy system of claim 24, wherein the plurality of non-contiguous periods of time are selected so that a difference in the respective weighted averages of spectral wavelengths between the first and second periods of time is greater than a threshold.

28. The solar energy system of any one of claims 23 to 27, wherein the plurality of non-contiguous periods of time are selected so that a difference in levels of solar irradiance between the first and second periods of time is greater than a threshold.

29. The solar energy system of any one of claims 23 to 28, wherein at least one of the plurality of periods of time is selected to improve a correlation between a spectral distribution of solar irradiance and a spectral response of the PV modules.

30. The solar energy system of any one of claims 23 to 29, wherein at least one of the plurality of periods of time is selected to maximize a correlation between a spectral distribution of solar irradiance and a spectral response of the PV modules.

31. The solar energy system of any one of claims 21 to 30, wherein the calculating of the value of the parameter of the calibration function is based in part on a weighted average of spectral wavelengths of visible light in the irradiance.

32. The solar energy system of any one of claims 21 to 31, wherein the non-transient computer-readable medium additionally stores program instructions that, when executed by the one or more processors, cause the one or more processors to identify one or more periods of time as being characterized by clear-sky conditions.

33. The solar energy system of any one of claims 21 to 32, wherein the non-transient computer-readable medium additionally stores program instructions that, when executed by the one or more processors, cause the one or more processors to report a fault in the irradiance sensor, responsively to the calculating of the value of the parameter of the calibration function.

34. The solar energy system of any one of claims 21 to 33, wherein the non-transient computer-readable medium additionally stores program instructions that, when executed by the one or more processors, cause the one or more processors to use the value of the parameter of the calibration function in setting a cleaning schedule of one or more of the PV modules.

35. The solar energy system of any one of claims 21 to 34, wherein the non-transient computer-readable medium additionally stores program instructions that, when executed by the one or more processors, cause the one or more processors to use the value of the parameter of the calibration function in a comparison of electricity production of the solar energy system with a projection based on the received measured values.

36. The solar energy system of any one of claims 21 to 35, wherein the non-transient computer-readable medium additionally stores program instructions that, when executed by the one or more processors, cause the one or more processors to report a possible fault of one or more PV modules responsively to accessing electrical output data of the solar energy system and the calculating of a value of the parameter of the calibration function.

37. The solar energy system of any one of claims 21 to 36, wherein calculating the value of the parameter of the calibration function includes using a multiplicative factor.

38. The solar energy system of any one of claims 21 to 37, wherein calculating the value of the parameter of the calibration function includes using an arithmetic factor to correct for bias in the received measured values.

39. The solar energy system of any one of claims 21 to 36, wherein the parameter of the calibration function is time-of-day and/or time-of-year dependent.

40. The solar energy system of any one of claims 21 to 36, wherein the calibration function compensates for an orientation of the irradiance sensor.

41. The solar energy system of any one of claims 21 to 40, wherein calculating the value of the parameter of the calibration function includes estimating bias in the received measured values and compensating for said bias.

42. The control system according to any one of claims 21 to 41.

43. A method of calibrating the irradiance sensor of the solar energy system of any one of claims 21 to 41, the method comprising:
a. receiving, from the irradiance sensor, the one or more measured values of solar irradiance for a period of time characterized by clear-sky conditions;
b. accessing the satellite irradiance data for the period of time, for the location including the irradiance sensor; and
c. comparing the one or more received measured values with the accessed satellite data to calculate the calibration function for the irradiance sensor,
wherein the receiving, accessing and comparing are carried out by the control system.

44. A method of calibrating an irradiance sensor of a solar energy system, the solar energy system additionally comprising a plurality of photovoltaic (PV) modules and a computing arrangement, the method comprising:
a. receiving, from the irradiance sensor, a plurality of measured values of solar irradiance for a period of time characterized by clear-sky conditions,
b. accessing satellite irradiance data for the period of time, for a location including the irradiance sensor, and
c. comparing the plurality of received measured values with the accessed satellite data to calculate a value of a parameter of a calibration function for the irradiance sensor,
wherein the receiving, accessing and comparing are carried out by the computing arrangement.

45. The method of claim 44, additionally comprising: selecting the period of time so as to improve a correlation between a spectral distribution of solar irradiance and a spectral response of the PV modules.

46. The method of claim 44, wherein (i) receiving the plurality of measured values of solar irradiance includes receiving a respective set of measured values for each of a plurality of non-contiguous periods of time, and (i) accessing the satellite irradiance data includes accessing satellite irradiance data for each of the plurality of non-contiguous periods of time.

47. The method of claim 46, wherein the plurality of non-contiguous periods of time comprises first and second periods of time respectively characterized by different weighted averages of spectral wavelengths of visible light in the solar irradiance.

48. The method of claim 47, additionally comprising: selecting the plurality of non-contiguous periods of time so as to increase a difference in the respective weighted averages of spectral wavelengths of the first and second periods of time.

49. The method of claim 47, additionally comprising: selecting the plurality of non-contiguous periods of time so as to maximize a difference in the respective weighted averages of spectral wavelengths of the first and second periods of time.

50. The method of claim 47, additionally comprising: selecting the plurality of non-contiguous periods of time so that a difference in the respective weighted averages of spectral wavelengths between the first and second periods of time is greater than a threshold.

51. The method of claim 47, additionally comprising: selecting the plurality of non-contiguous periods of time so that a difference in levels of solar irradiance between the first and second periods of time is greater than a threshold.

52. The method of claim 47, additionally comprising: selecting at least one of the plurality of non-contiguous periods of time so as to improve a correlation between a spectral distribution of solar irradiance and a spectral response of the PV modules.

53. The method of claim 47, additionally comprising: selecting at least one of the plurality of non-contiguous periods of time so as to maximize a correlation between a spectral distribution of solar irradiance and a spectral response of the PV modules.

54. The method of any one of claims 44 to 53, wherein the calculating of the value of the parameter of the calibration function is based in part on a weighted average of spectral wavelengths of visible light in the irradiance.

55. The method of any one of claims 44 to 54, additionally comprising: identifying one or more periods of time as being characterized by clear-sky conditions.

56. The method of any one of claims 44 to 55, additionally comprising: reporting a fault in the irradiance sensor, responsively to the calculating of the value of the parameter of the calibration function.

57. The method of any one of claims 44 to 56, additionally comprising: using the value of the parameter of the calibration function in setting a cleaning schedule of one or more of the PV modules.

58. The method of any one of claims 44 to 56, additionally comprising using the value of the parameter of the calibration function in a comparison of electricity production of the solar energy system with a projection based on the received measured values.

59. The method of any one of claims 44 to 56, additionally comprising: reporting a possible fault of one or more PV modules responsively to accessing electrical output data of the solar energy system and calculating a value of the parameter of the calibration function.

60. The method of any one of claims 44 to 56, wherein calculating the calibration function includes using a multiplicative factor.

61. The method of any one of claims 44 to 56, wherein calculating the value of the parameter of the calibration function includes using an arithmetic factor to correct for bias in the received measured values.

62. The method of any one of claims 44 to 56, wherein the calibration function is time-of-day and/or time-of-year dependent.

63. The method of any one of claims 44 to 56, wherein the calibration function compensates for an orientation of the irradiance sensor.

64. The method of any one of claims 44 to 63, wherein comparing the one or more received measured values includes estimating bias in the received measured values and compensating for said bias.

65. The method of any one of claims 44 to 64, additionally comprising projecting electricity production of the solar energy system, using one or more calculated values of the calibration function for the irradiance sensor.

66. The method of claim 65, wherein the projecting includes predicting electricity production for a future period.

67. The method of claim 65, wherein the projecting includes modeling electricity production for a past period.

68. The method of any one of claims 65 to 67, wherein the projecting is improved by using the one or more calculated values of the calibration function for the irradiance sensor.

69. A method of calibrating an irradiance sensor of a weather station comprising an irradiance sensor and a computing arrangement, the method comprising:
a. receiving, from the irradiance sensor, a plurality of measured values of solar irradiance for a period of time characterized by clear-sky conditions;
b. accessing satellite irradiance data for the period of time, for a location including the irradiance sensor; and
c. comparing the plurality of received measured values with the accessed satellite data to calculate a calibration function for the irradiance sensor,
wherein the receiving, accessing and comparing are carried out by the computing arrangement.
